(19) United States
(12) Patent Application Publication
(10) Pub. No.: US 2003/0129058 A1
(43) Pub. Date: Jul. 10, 2003

(54) Dual use fan and viewing article

(76) Inventor: Richard Francis Carollo, Orland Park, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/042,980

(22) Filed: Jan. 9, 2002

(51) Int. Cl. F03D 11/00

(52) U.S. Cl. 416/5

(57) ABSTRACT

A dual use fan and viewing article is disclosed. The article may be used as a hand fan, and the article may be used to view an event such as a sporting event or a fireworks display. In one embodiment, viewing is enhanced by a light attenuating film. In another embodiment, viewing is enhanced by a light reflecting film. In yet another embodiment, viewing is enhanced by a prism effect film.

### TECHNICAL FIELD

The present invention relates in general to promotional articles and, in particular, to dual use fan and viewing articles.

### BACKGROUND

Often, companies and other organizations promote their organizations, products, and/or services through custom printed promotional items. Typically, these items have some practical value in order to encourage the recipient to accept and/or retain the promotional item. For example, mugs, pens, key chains, hats, etc. may be custom printed to include a company logo. In some instances, these promotional items and/or other retail items are distributed at a company sponsored event such as a picnic or fireworks display. In such an instance, the practical value of some items is diminished. For example, a hat may be useful at a picnic, but a mug or pen may not be useful at a picnic.

### BRIEF DESCRIPTION OF THE DRAWINGS

Features and advantages of the disclosed article of manufacture will be apparent to those of ordinary skill in the art in view of the detailed description of exemplary embodiments which is made with reference to the drawings, a brief description of which is provided below.

FIG. 1 is a front view of an exemplary dual use fan and viewing article.

FIG. 2 is a back view of an exemplary dual use fan and viewing article.

FIG. 3 is a schematic illustration of an exemplary circular fan blade.

FIG. 4 is a schematic illustration of an exemplary bread slice shaped fan blade.

FIG. 5 is a schematic illustration of an exemplary palm leaf shaped fan blade.

FIG. 6 is a schematic illustration of an exemplary octagonal fan blade.

FIG. 7 is a schematic illustration of an exemplary square fan blade.

FIG. 8 is a schematic illustration of additional exemplary fan blade shapes.

FIG. 9 is a schematic illustration of further exemplary fan blade shapes.

FIG. 10 is a schematic illustration of exemplary fan blade shapes including a perforated tear-off portion.

### DETAILED DESCRIPTION OF EXEMPLARY EMBODIMENTS

In general, the article described herein is a dual use fan and viewing article. The article may be used as a hand fan, and the article may be used to view an event such as a sporting event or a fireworks display. In one 5 embodiment, viewing is enhanced by a light attenuating film. In another embodiment, viewing is enhanced by a light reflecting film. In yet another embodiment, viewing is enhanced by a prism effect film.

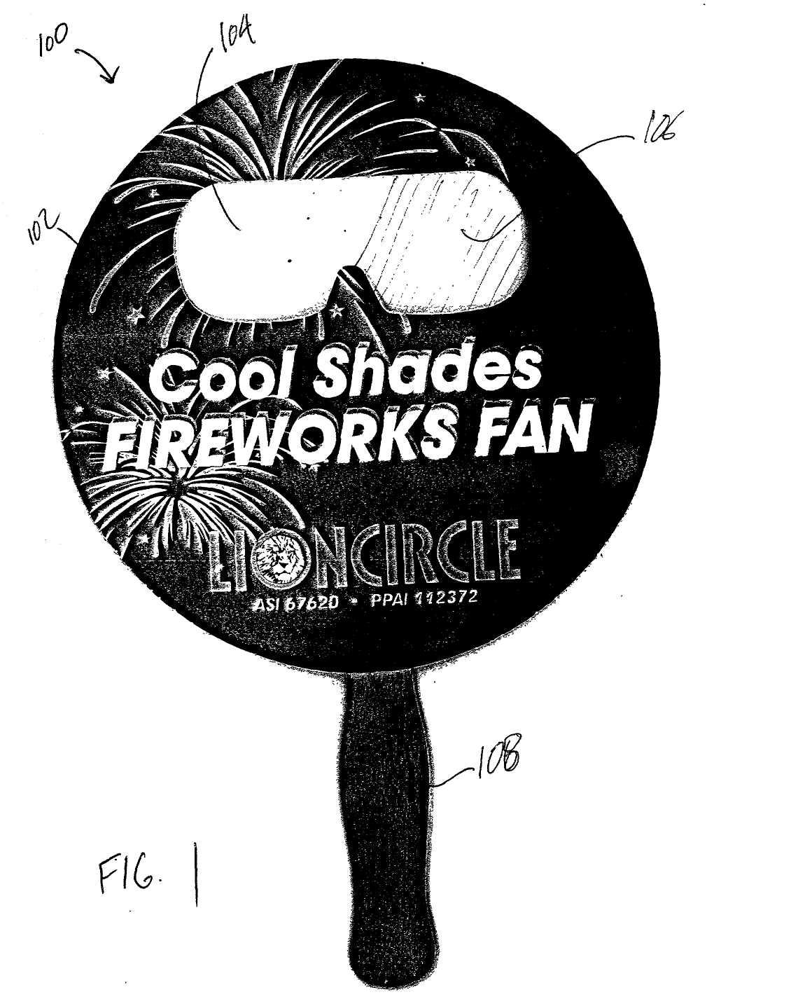

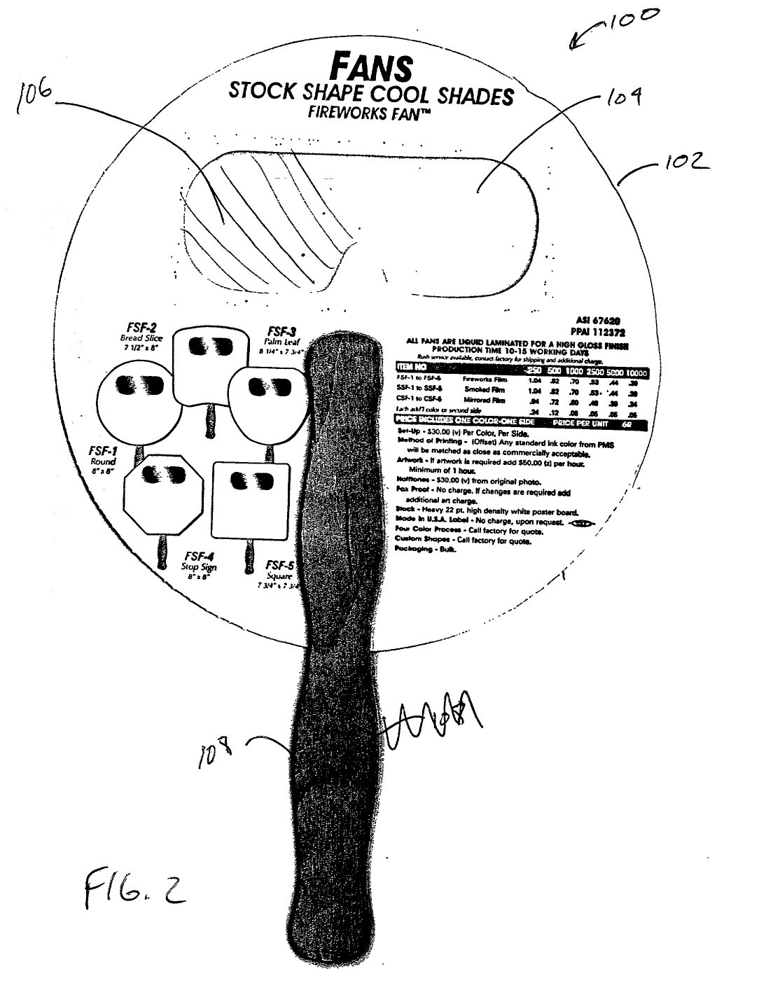

A front view of an exemplary dual use fan and viewing article is illustrated in FIG. 1. A back view of the exemplary dual use fan and viewing article is illustrated in FIG. 2. In this embodiment, the article includes a fan blade 102, a viewing aperture 104, a translucent film 106, and a support arm 108. The fan blade may be any shape, such as a circle, square, triangle, etc., as described in more detail below. Preferably, the fan blade 102 is constructed from heavy stock poster board. In some embodiments, the fan blade 102 is liquid laminated on at least one side in a well known manner to produce a high gloss finish. For example, the fan blade 102 may be covered with a clear gloss ultraviolet (UV) coating. The fan blade 102 may include printing on one or both sides. The printing may be black and/or colored.

The viewing aperture 104 may also be any shape. The viewing aperture 104 is generally shaped to allow binocular viewing by adults and/or children. In the preferred embodiment, the viewing aperture 104 is a single opening with a predefined shape. In an alternate embodiment, the viewing aperture 104 includes two or more holes.

Preferably, the translucent film 106 is constructed from polyester. The translucent film 106 may be a light attenuating film, a light reflecting film, and/or a prism effect film. The light attenuating film may be a deep dyed polyester. The light reflecting film may be a metalized deep dyed polyester. In one embodiment, aluminum is vacuum deposited on one side of the translucent film 106 to create a mirrored effect. The prism effect film may be an embossed and/or coated polyester film. For example, the translucent film 106 may be embossed with a cross-star pattern. In the preferred embodiment, the translucent film 106 is between one and three mils thick. The translucent film 106 may be attached to the fan blade 102 in any well known manner. For example, the translucent film 106 may be glued to the fan blade 102 with a water based adhesive (e.g., “wet glue”). Preferably the translucent film 106 covers some or all of the viewing aperture 104.

Preferably, the support arm 108 is constructed from wood and/or plastic. The support arm 108 may be of any length (e.g., 2-16 inches), width (e.g., 0.25-3 inches), and/or thickness (e.g., 0.01-0.25 inches). In the preferred embodiment, the support arm 108 is approximately eight inches long and one inch wide. Preferably, the support arm 108 includes a wave-shaped edge to facilitate gripping by a human hand. The support arm 108 may be attached to the fan blade 102 in any well known manner. For example, the support arm 108 may be glued or stapled to the fan blade 102 with hot melt adhesive.

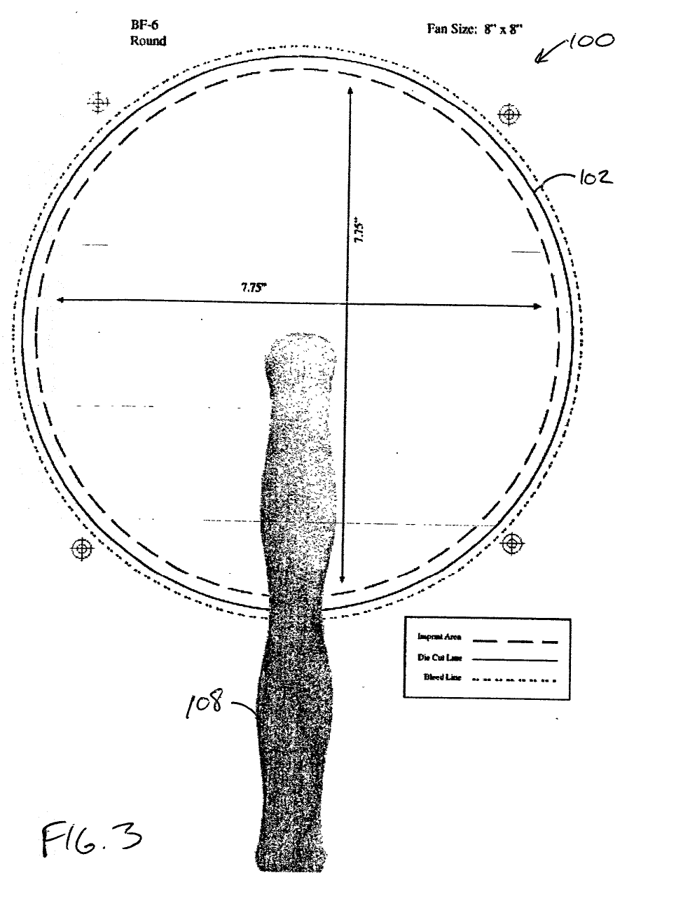

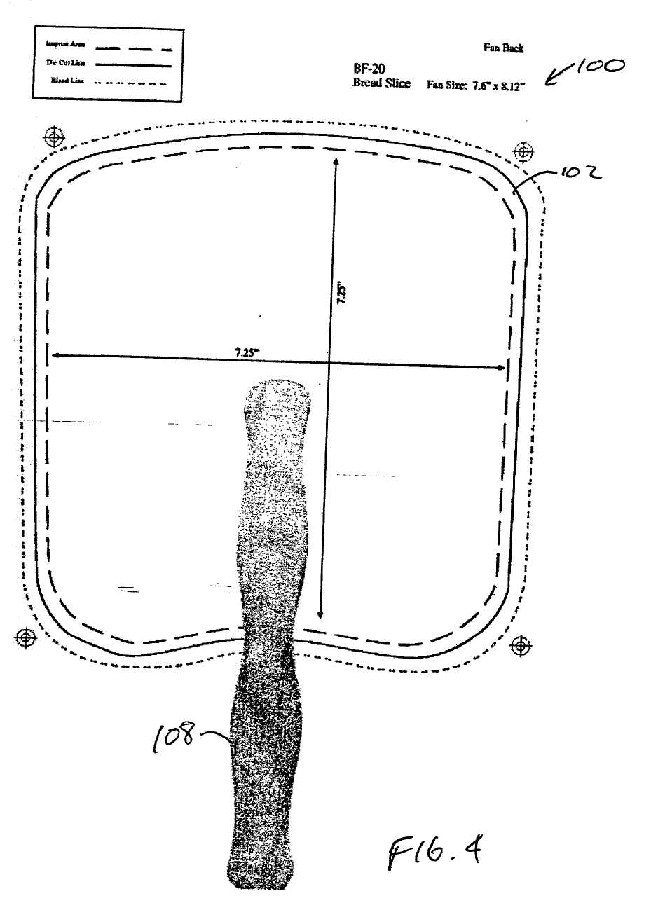

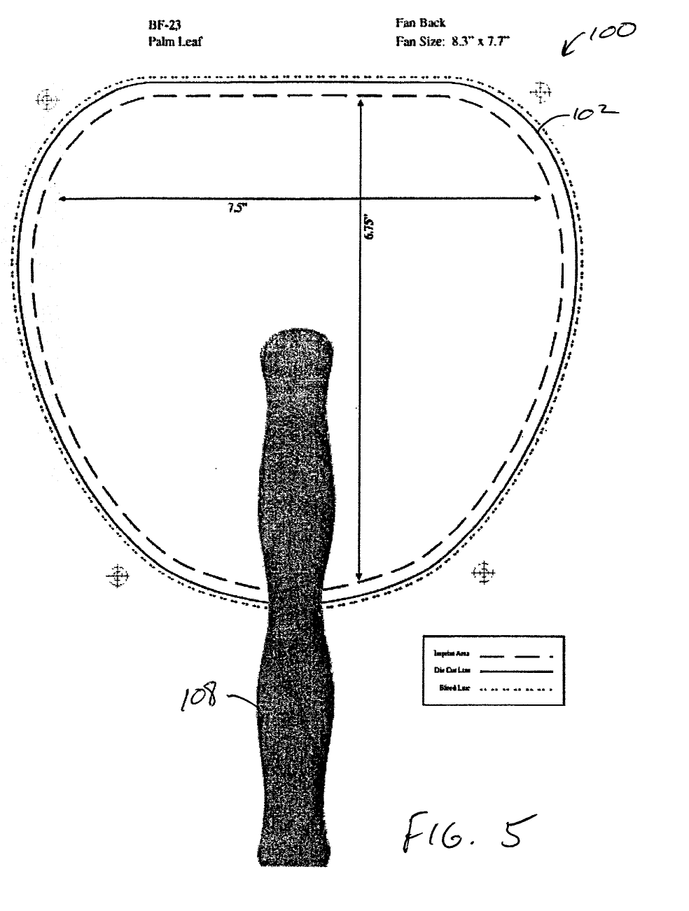

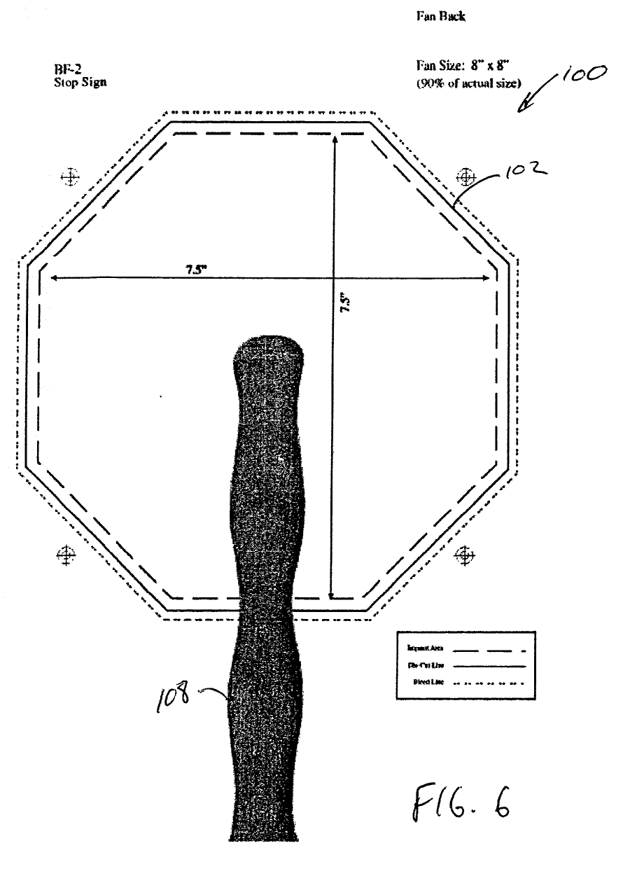

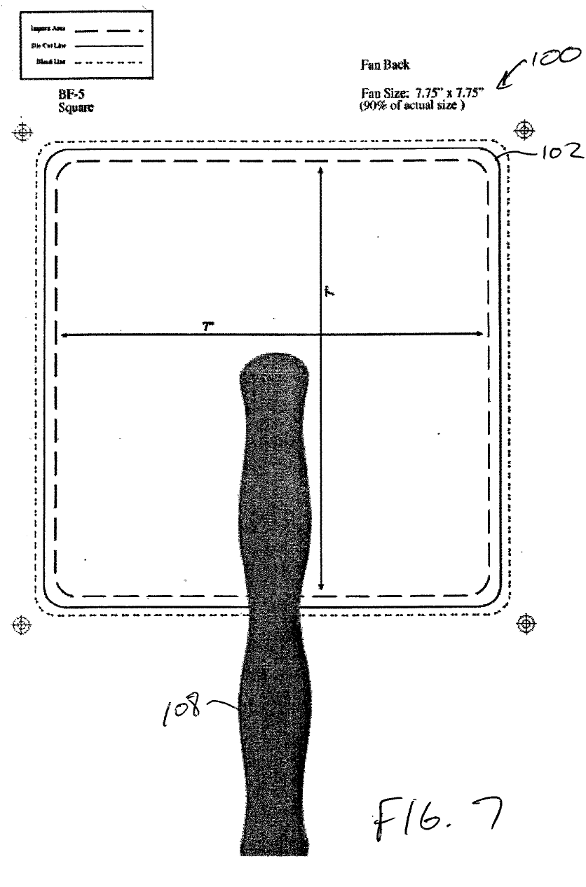

A person of ordinary skill in the art will readily appreciate that any shape may be used for the fan blade 102. In addition, the fan blade 102 may be constructed to any predetermined dimensions. An exemplary circular fan blade 102 is illustrated in FIG. 3. In this embodiment, the fan blade 102 is approximately 7.75″ by 7.75″. An exemplary bread slice shaped fan blade 102 is illustrated in FIG. 4. In this embodiment, the fan blade 102 is approximately 7.25″ by 7.25″. An exemplary palm leaf shaped fan blade 102 is illustrated in FIG. 5. In this embodiment, the fan blade 102 is approximately 7.5″ by 6.75″. An exemplary octagonal fan blade 102 is illustrated in FIG. 6. In this embodiment, the fan blade 102 is approximately 7.5″ by 7.5″. An exemplary square fan blade 102 is illustrated in FIG. 7. In this embodiment, the fan blade 102 is approximately 7″ by 7″.

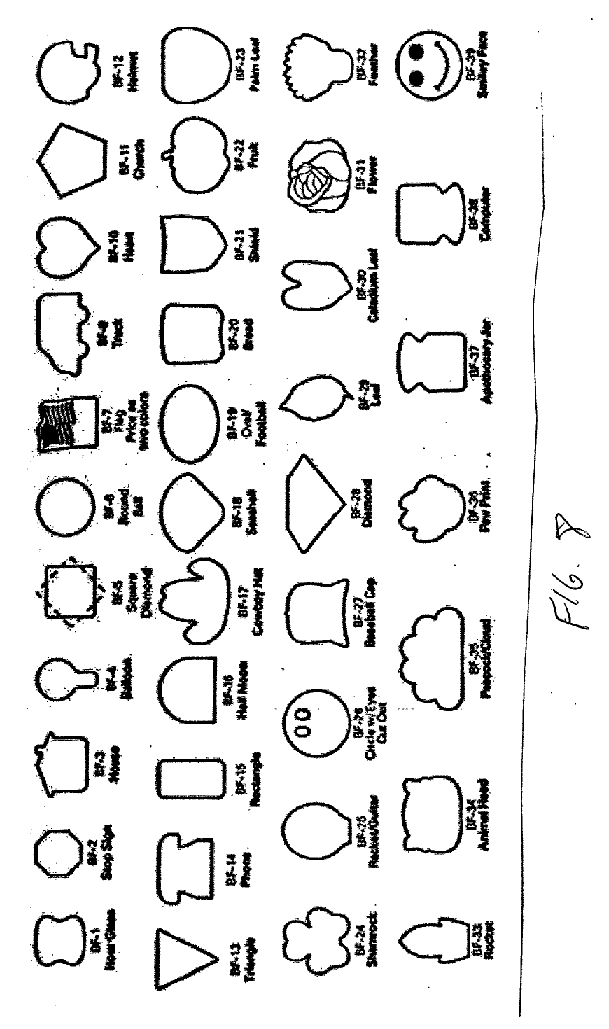

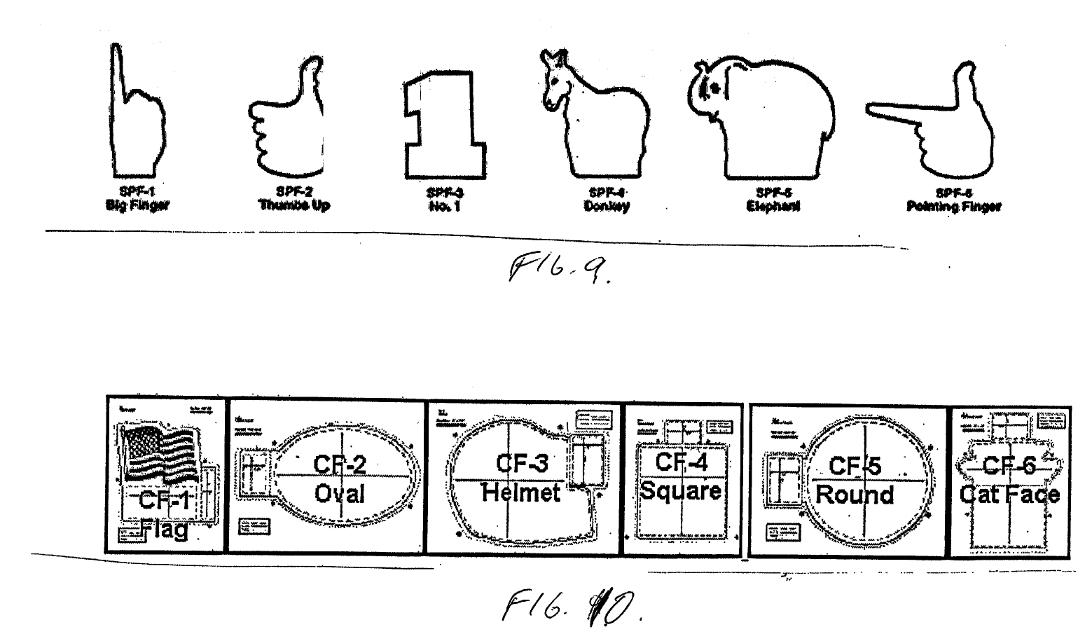

Additional exemplary fan blade shapes are illustrated in FIG. 8. Further exemplary fan blade shapes are illustrated in FIG. 9. Exemplary fan blade shapes including a perforated tear-off portion are illustrated in FIG. 10. In these embodiments, the fan blade 102 includes a portion which is structured for removal from the rest of the fan blade 102. For example, a removable coupon may be included with the fan blade 102.

In summary, persons of ordinary skill in the art will readily appreciate that a dual use fan and viewing article has been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description, but rather by the claims appended hereto.

What is claimed is:

1. A dual use fan and viewing article comprising:
a support arm having an arm length, an arm width, and an arm thickness, the arm length being at least two times larger than the arm width, the arm width being at least two times larger than the arm thickness;
a fan blade mechanically coupled to the support arm, the fan blade including a viewing aperture, the fan blade having a largest dimension, the largest dimension being less than five times the arm length, the largest dimension being more than one fourth of the arm length; and
a translucent film mechanically coupled to the fan blade, the translucent film covering at least 75% of the viewing aperture.

2. An article as defined in claim 1, wherein the translucent film comprises a light attenuating film.

3. An article as defined in claim 2, wherein the translucent film comprises a light reflecting film.

4. An article as defined in claim 2, wherein the translucent film comprises a prism effect film.

5. An article as defined in claim 4, wherein the translucent film comprises a light reflecting film.

6. An article as defined in claim 1, wherein the translucent film comprises a light reflecting film.

7. An article as defined in claim 1, wherein the translucent film comprises a prism effect film.

8. An article as defined in claim 1, wherein the translucent film covers 100% of the viewing aperture.

9. An article as defined in claim 1, wherein the translucent film is mechanically coupled to the fan blade by glue.

10. An article as defined in claim 1, wherein the support arm includes a wave-shaped edge.

11. An article as defined in claim 1, wherein the support arm comprises wood.

12. An article as defined in claim 1, wherein the fan blade includes a liquid laminated high gloss finish.

13. An article as defined in claim 1, wherein the fan blade includes a tear-off portion.

14. An article as defined in claim 1, wherein the fan blade defines a circular shape.

15. An article as defined in claim 1, wherein the fan blade defines an octagonal shape.

16. An article as defined in claim 1, wherein the fan blade defines a square shape.

17. An article as defined in claim 1, wherein the fan blade defines a square shape with rounded corners.

18. An article as defined in claim 1, wherein the fan blade defines a bread slice shape.

19. An article as defined in claim 1, wherein the fan blade defines a palm leaf shape.

20. An article as defined in claim 1, wherein the fan blade comprises poster board.

21. An article as defined in claim 1, wherein the fan blade includes a printed side.

22. An article as defined in claim 1, wherein the fan blade includes a first side and a second side, the first side including color printing, the second side including black printing, the second side excluding color printing.

23. An article as defined in claim 22, wherein the first side includes a liquid laminated high gloss finish.

24. An article as defined in claim 22, wherein the first side of the fan blade is mechanically coupled to the support arm.

25. An article as defined in claim 22, wherein the second side of the fan blade is mechanically coupled to the support arm.

26. An article as defined in claim 1, wherein the fan blade is mechanically coupled to the support arm by glue.

27. An article as defined in claim 1, wherein the viewing aperture has an area greater than one square inch and less than 30 square inches.

28. An article as defined in claim 1, wherein the viewing aperture comprises two holes.

29. A dual use fan and viewing article comprising:
a wooden handle having a handle length, a handle width, and a handle thickness, the handle length being at least two times larger than the handle width, the handle width being at least two times larger than the handle thickness;
a poster board fan blade glued to the wooden handle, the poster board fan blade including a viewing aperture, the viewing aperture having an area greater than one square inch and less than 20 square inches, the poster board fan blade having a largest dimension, the largest dimension being less than three times the handle length, the largest dimension being more than one half the handle length, the poster board fan blade including a first side and a second side, the first side including color printing; and
a translucent film mechanically coupled to the fan blade, the translucent film covering at least 90% of the viewing aperture, the translucent film comprising a light attenuating and prism effect film.

30. An article as defined in claim 29, wherein the second side includes black printing and excludes color printing.

31. An article as defined in claim 29, wherein the poster board fan blade defines at least one of a circular shape, an octagonal shape, a square shape, a square shape with rounded corners, a bread slice shape, and a palm leaf shape.
